(19) United States
(12) Patent Application Publication
(10) Pub. No.: US 2013/0206026 A1
(43) Pub. Date: Aug. 15, 2013

(54) STAMP PRESS

(71) Applicant: Henry Stephen Konik, Lancaster, CA (US)

(72) Inventor: Henry Stephen Konik, Lancaster, CA (US)

(21) Appl. No.: 13/370,525

(22) Filed: Feb. 10, 2012

(51) Int. Cl. B41K 3/00

(52) U.S. Cl. 101/368

(57) ABSTRACT

This apparatus is small, compact, and light-weight, relatively inexpensive in terms of manufacturing cost, and will substantially improve the quality of a stamped image, also used for repetitive printing on individual sheets of card stock or any flat printable surface, in the same pre-determined location, set be the user, which provides maximum flexibility in arrangement and adjustment to permit the apparatus to be used with various sizes of stamps, and various types of card stock and to be used to make a consistent inked impression at virtually any location on selected card stock.

### BACKGROUND

### Prior Art

Handheld stamps have been used for years to imprint words and images onto paper and have become the mainstay of many greeting card creators. Generally, stamping comprises of three-step process: first, the application of ink via an ink pad or roller to the stamp. Second, the positioning of the stamp in the general area chosen by creator and third, pressing the inked stamp firmly onto paper or specific medium.

The transfer process generally provides an acceptable image with relatively modest applied pressure. However, several problems are encountered as complexity or size of the transfer image and location of the stamp onto the paper surface. Amongst these problems are ink coverage that may be less-than-complete, resulting in a stamped image that is also incomplete or with varied ink density. Mainly, this issue is attributed to ink pad distribution inconsistencies caused by ink roller unevenness (pressure or ink coverage), or a creator's own inability to judge the ink coverage of the stamp.

Furthermore, manually applied pressure to the stamp may be uneven across the total area of a stamp-paper interface, thus resulting in the stamped image density that varies according to local pressure applied. For example, the left side of a stamp image may be lighter than the right side if creator applied more pressure to the right side of the stamp, hence, manually applying proper pressure evenly across a large stamp, often requiring much practice or trial-and-error, thereby requiring large quantities of ink and supplies.

In addition, the stamp itself may be uneven across its inking surface, thus the density of applied ink may be proportional to the relative height of the stamp surface to paper. For example, an uneven stamp can print an uneven image (with regard to image density). Said problem is exacerbated by the use of large stamps, wherein tight in-plane tolerances must be met over proportionally large area.

Also, by manually positioning the stamp via measuring the location on the card or print medium using a ruler or other measuring device and marking its location within an area that the image is desired, this is very time consuming.

Another problem appears when a repetitive operation is required and thus consistency in the image produced. Namely, were a greeting card creator must reproduce numerous amount of identical cards, with the same image, same density, and at the same location on the card or print medium. The present solution to repetitive operation is as follows; the greeting card creator must plot on each card or print medium, the location of the image by measuring its location each and every time the image is required. Again, greeting card creator must address aforementioned problems, which often require much practice or trial-and-error, thereby resulting in the use of large quantities of ink and supplies.

The aforementioned problems are alleviated, at least in part, by the use of a manually operated printing press wherein a stamp is inked then subsequently placed in a vise-like apparatus that applies heavy pressure to the stamp-paper interface. This method is, of course, hundreds of years old, and the fundamental practice remains unchanged.

While said printing method works well for professional stamper, many stamping hobbyists cannot afford the often-bulky and precision-made printing press. Although inexpensive versions of printing presses are commercially available, many of these products are prone to image quality issues that are evident with manual stamping methods; i.e., if ink distribution is uneven across a stamp, the resulting stamped image will also be uneven. This problem is compounded by the use of large or complex stamps.

Some greeting card creators have used a simple fold-over method for manually printing small quantities of greeting cards. This method begins by folding a blank greeting card in half, then applying ink to the stamp, roughly aligning the edges of the paper with the edges of the inked stamp, and finally, subsequently uses fingertips pressure to transfer the inked image to the greeting card front cover. Although this manual method can ameliorate the problems of uneven stamp surface and provide, with practice, a more-consistent image, it does not eliminate them. Several problems still remain. The first lies within the re-inking of a stamp—if required to correct a spotty image—is not practical (paper and stamp would likely be misaligned on second printing). The second is the precise positioning of the stamp in which the stamped image needs to be roughly the size of the greeting card. For example, centering a small image on a large card can be rather difficult. Lastly, the method is still get-it-right-the-first-time technique, in which inadequate pressure may result in the rejection of the finished product.

### SUMMARY

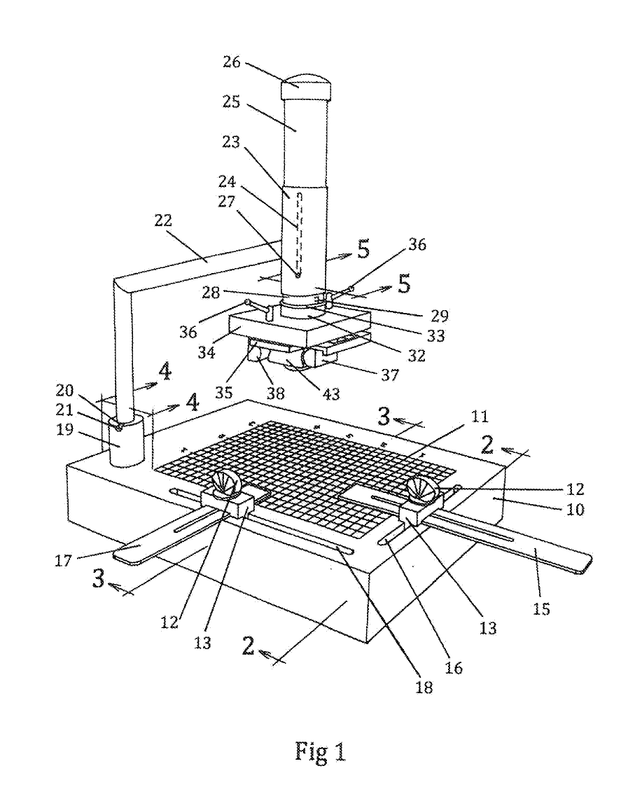

In accordance with one embodiment, the traditional manual methods require much practice, and large printing presses are expensive. Many stamping hobbyist simply avoid large and complex stamps. Present embodiment solves the aforementioned stamp problems, by the printing apparatus as shown in FIG. 1.

### DRAWINGS—

### Figures

FIG. 1 is a perspective drawing of a preferred embodiment of this invention.

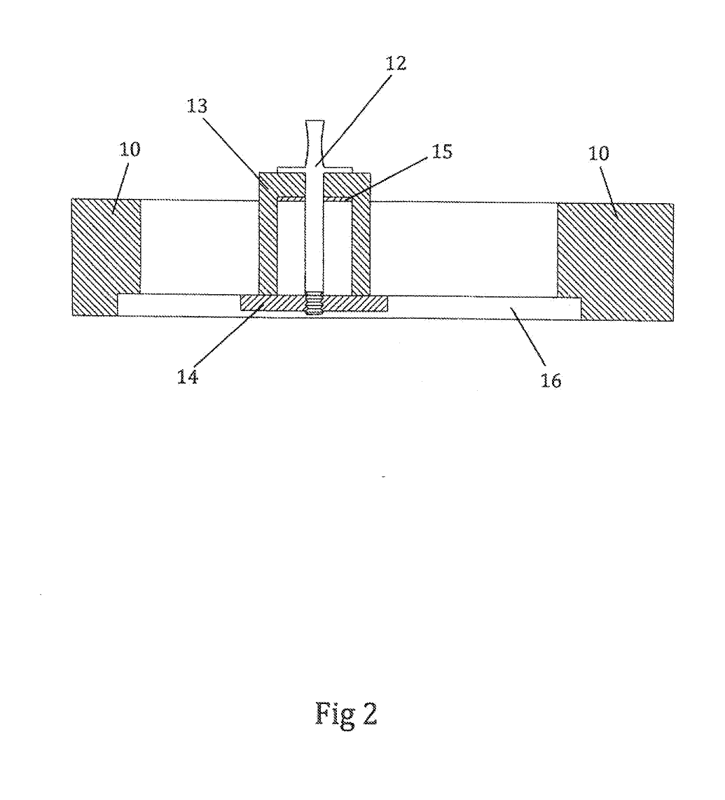

FIG. 2 is a view in detail of portion indicated by the section lines 2-2 in FIG. 1.

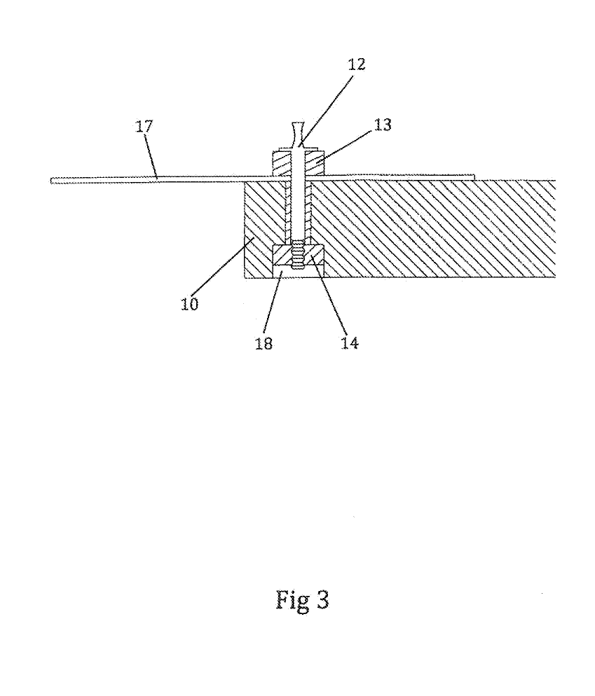

FIG. 3 is a view in detail of portion indicated by the section lines 3-3 in FIG. 1.

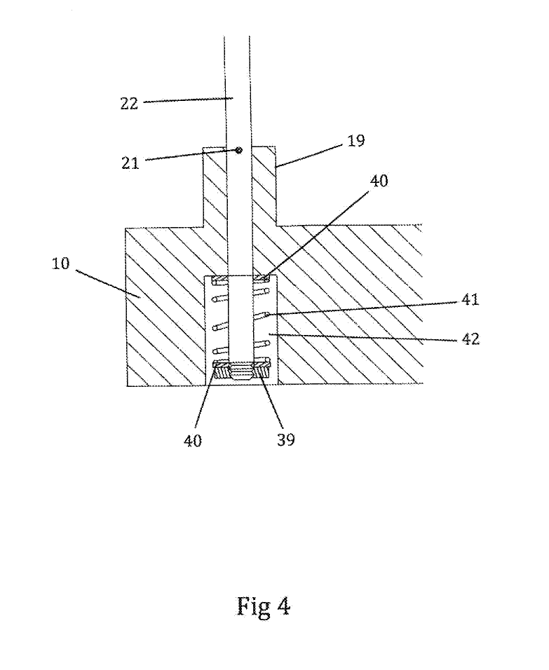

FIG. 4 is a view in detail of portion indicated by the section lines 4-4 in FIG. 1.

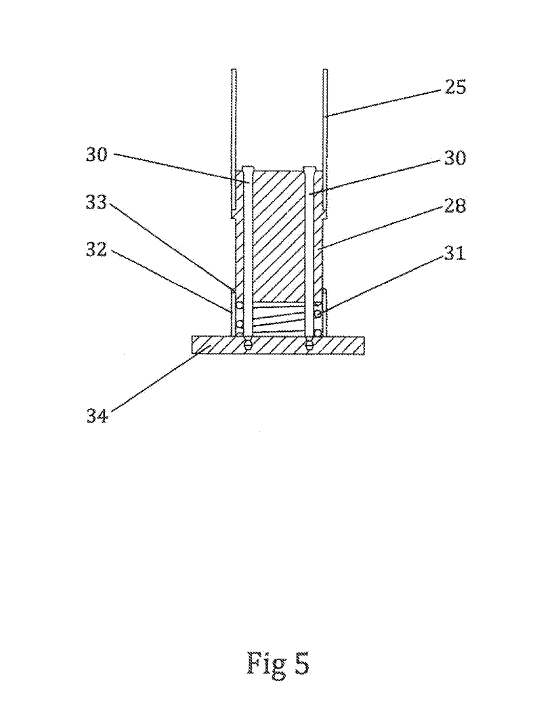

FIG. 5 is a view in detail of portion indicated by the section lines 5-5 in FIG. 1.

### REFERENCE NUMERALS

| | | | |
|---|---|---|---|
| 10 | Bed | 11 | Grid Lines |
| 12 | Slider Thumbscrew | 13 | Slider |
| 14 | Slider Nut | 15 | Vertical Ruler |
| 16 | Vertical T-slot | 17 | Horizontal Ruler |
| 18 | Horizontal T-slot | 19 | Boss |
| 20 | Boss Groove | 21 | Boss Pin |
| 22 | Support Shaft | 23 | Guide |
| 24 | Guide Groove | 25 | Plunger |
| 26 | Plunger Cap | 27 | Guide Pin |
| 28 | Rotator | 29 | Indicator |
| 30 | Screw | 31 | Gauge Spring |
| 32 | Gauge Sleeve | 33 | Reference Ring |
| 34 | Upper Plate | 35 | Lower Plate |
| 36 | Lever | 37 | Inner Finger |
| 38 | Outer Finger | 39 | Shaft Nut |
| 40 | Washer | 41 | Shaft Spring |
| 42 | Bed Cavity | 43 | Stamp |

### DETAILED DESCRIPTION

### First Embodiment—FIG. 1

Referring to the perspective view FIG. 1, a preferred embodiment of my invention as comprising of a flat bed 10 adapted to receive and support one sheet of paper stock, or one envelope, or one blank form, or other medium upon which the printed impression is to be made on by means of paper stock alignment and securing it to bed 10, a plunger 25 by means to make the impression, and means to apply ink to stamp 43.

To facilitate accurate positioning of the sheet of paper stock, imprinted on the upper hard smooth surface of the bed 10 are appropriate grid lines 11. Said grid lines 11, commencing at four centimeter from bed 10 edge with interval of one-millimeter and parallel to vertical T-slot 16 and horizontal T-slot 18. Numerical graduation index are imprinted on bed 10 surface, reading horizontally left to right and vertically top to bottom.

Referring to FIG. 1, this embodiment requires two of slider 13, which are constructive identically; hence, one is used for longitude travel in horizontal T-slot 18 and the other travels latitude in vertical T-slot 16. Vertical ruler 15 is sandwich between slider 13, which travels latitude in vertical T-slot 16 and the surface of said bed 10. Horizontal ruler 17 is sandwich between slider 13, which travels longitude in horizontal T-slot 18 and the surface of said bed 10. Both sliders and rulers are used to align said paper stock, in the predetermined location and to maintain that position for image transfer. This predetermine location will allow the user to perform repetitive stamping operation on a consecutive sheet of paper stock with out any further alignment of said sliders or rulers.

Referring to FIG. 2 and FIG. 3, as stated, said slides 13 accompanying said vertical ruler 15 and said horizontal ruler 17 are adjustably secured to said bed 10. The adjustable securing means includes slider thumbscrew 12, slider 13, and slider nut 14. The slider 13 is rectangular form, having width and thickness dimension selected to make a freely sliding fit within the narrow portion of the T-slots. The sliders are made of sufficient length to freely slide within the slot without turning or binding, and are preferably given the length of the eight-millimeter plus the width of said ruler.

At the center of each slider 13 a threaded slider thumbscrew 12 extends downwardly through appropriate opening in the under side of the slider 13 as illustrated in FIG. 2 and FIG. 3 to pass through the narrow portion of the T-slot. The slider thumbscrew 12 is received by the slider nut 14 within the bottom cross bar portion of the T-slot. Hence, by manipulation of the slider thumbscrew 12 in a clockwise rotation, the slider nut 14 is drawn upwards to engage with the underside of that portion of the material of the bed 10, which overhangs the wide part of the T-slot. Hence, the slider and ruler are securely clamped to the upper surface of said bed 10. By turning slider thumbscrew 12 counterclockwise, this releases said slider, hence allowing said slider to slide freely within the T-slot.

Referring to FIG. 1, said horizontal T-slot 18 commencing four centimeters from corner opposite boss 19 and two centimeters parallel along longitude edge of said bed 10 at right angle to the latitude edge. Horizontal T-slot 18 which extending three quarters of the longitude length of said bed 10. T-slot width will accommodate slider 13.

Again, referring to FIG. 1, said vertical T-slot 16 commencing four centimeter from corner opposite boss 19 and two centimeters parallel along latitude edge of said bed 10 at right angle to the longitude edge. Vertical T-slot 16 which extending three quarters of the latitude length of said bed 10. T-slot width will accommodate slider 13.

The inked impression is made by a conventional stamp, which is available commercially, and comes in different sizes and images, is being illustration in FIG. 1 indicated generally by reference character 43. Referring to FIG. 1, the stamp 43 is supported between movable inner finger 37, which slides through movable outer finger 38. Both fingers are of the same thickness. By means of rotating lever 36 clockwise, causing lower plate 35 to be drawing up into upper plate 34, hence, sandwiching inner finger 37 and outer finger 38 in a vise grip action between plates, hence securing stamp 43 firmly in position. By rotating lever 36 counterclockwise releasing lower plate 35, allowing inner finger 37, and outer finger 38 to slide freely apart between upper plates 34 and lower plate 35, hence releasing stamp 43.

Referring to FIG. 1 and FIG. 5, rotator 28 is machined from a sold piece of material, which fits partially into plunger 25, below guide pin 27. Upper plate 34 is fixed by means of two screws 30 that act as guide pins. The screws 30 pass through the rotator 28 and are allowed to slide freely in the rotator 28 but are secured to the upper plate 34 with a gap of 10 mm between rotator 28 and upper plate 34. A gauge spring 31 of low straight is placed in between the rotator 28, upper plate 34 and inside gauge sleeve 32. Gauge sleeve 32 is constructed from the same material and thickness as guide 23 with a height of 12 mm. The gauge sleeve 32 sits freely around rotator 28 and in contact with upper plate 34. Reference ring 33 fits snugly around rotator 28 above gauge sleeve 32. Downwards force that is applied by the user onto plunger cap 26 and at the moment when the stamp 43 comes in contact with ether the ink pad or print stock, gauge sleeve 32 is moved upwards making contact with reference ring 33, hence moving it up the indicator 29 to indicate desired pressure.

Once downward force on plunger cap 26 is reversed, plunger spring, (not shown) which sits on guide pin 27 inside said plunger 25 and upper portion of plunger spring is in contact with plunger cap 26 again inside said plunger 25, provides pressure that will return plunger 25 upwards to its neutral state and the gauge spring 31 between rotator 28 and upper plate 34 will push rotator 28 and upper plate 34 apart. The reference ring 33 will remain in its position as the gauge sleeve 32 is no longer making contact with it and resting on upper plate 34. Reference ring 37 will indicate on the indicator 29, the amount of pressure that was applied.

The rotator 28 can execute a three hundred sixty degree rotation, horizontal to surface of said bed 10. This allows the stamp 43 to be positioned at the user's desired angle, relative to both sliders 13.

Securing users desired angles by means of turning plunger cap 26 clockwise, drawing up tension rod, (not shown), which will drawing rotator 28 into plunger 25 securing rotator 28 in the predetermined alignment. The tension rod passes through plunger spring, (not shown), and will not interfere with plunger 25 vertical movements. The tension rod is threaded at both ends. One end of the tension rod is threaded into plunger cap 26 and allowed to turn. The other end is threaded into rotator 28 and is secured from movement.

Referring to FIG. 1, plunger 25 extends through guide 23 and is held in check by guide pin 27. Said plunger 25 downward depth movement is pre-set by the length of guide groove 24. Guide groove 24 has the width of guide pin 27. There are two grooves opposite each other and there length will allow the stamp 43 to make contact with said bed 10, once said stamp 43 is secured between inner finger 37 and outer finger 38. Upward force is provided by plunger spring, (not shown), which sits on guide pin 27 inside said plunger 25 and upper portion of plunger spring is in contact with plunger cap 26 again inside said plunger 25, hence placing plunger 25 in operational position.

Referring to FIG. 1 and FIG. 4, support shaft 22 extends through boss 19 and bed 10 to bed cavity 42, but not extending beyond bottom surface of bed 10. Boss pin 21 is seated into boss groove 20 by shaft spring 41 which is sandwich between washers 40 secured by means of shaft nut 39 to threaded support shaft 22 end. Referring to FIG. 1, said support shaft 22 length allows said guide 23 to be center over said bed 10.

While various materials are suitable for making said bed 10, plastic composition has the desired characteristics of strength, rigidity, lightweight, workability, allowing for smooth, hard exterior surface, at a low construction cost. The said bed 10 preferably length and width dimension are larger than the corresponding dimension of a sheet of stock paper to be imprinted by the user of the apparatus. Bed size of approximately twenty-five centimeter by thirty-eight centimeter provides an adequately large bed surface, while at the same time presenting length and width dimensions which are sufficiently small to allow the apparatus to be stored in a small space when not in use. Said plunger 25, said guide 23, and said support shaft 22 are preferably made of lightweight aluminum or some other lightweight material that provides straight and ease of manufacture. Slider 13, inner finger 37, and outer finger 38 preferably made from lightweight material.

From the foregoing it will be observed that I have provided a stamping apparatus of extremely simple construction which is small, compact, and light-weight, and so arranged as to permit the apparatus to be manufactured at low cost. It will be noted that the stamp 43 may be interchanged with different stamps of different sizes and images, easily by merely releasing the lever 36, spread the inner finger 37 and outer finger 38 outwards. Attention is directed particularly to the arrangement of vertical T-slot 16, horizontal T-slot 18 and the mechanism used for adjustable slider 13 to bed 10, as these features provide maximum flexibility in securing the arrangement that permit the apparatus to be used with various sizes and types of paper stock or other printable stock. Hence, making the inked impression virtually in any location on the selected printable stock that can fit on bed 10.

### Operation—First Embodiment—FIG. 1

The user places paper stock on bed 10 under lower plate 35. Once desired positioning of said paper stock is located, the user adjusts slider 13 in horizontal T-slot 18 and adjusts horizontal ruler 17 to extend and contact paper stock edge. The user then adjusts slider 13 in vertical T-slot 16 and adjusts vertical ruler 15 to extend and contact paper stock edge, hence, orienting paper stock parallel to bed 10 outer edges. This action secured the paper stock from moving on said bed 10.

The user select appropriate designed stamp 43, said stamp 43 is then held between inner finger 37 and outer finger 38 under lower plate 35. The user then applies pressure to the outside of said inner finger 37 and outer finger 38, sandwiching said stamp 43, then by means of rotating lever 36 this firmly securing stamp 43 in desired position.

The user selects the desired orientation of said stamp 43 to said printable stock by means of rotating the rotator 28. Then by turning means of plunger cap 26, securing rotator 28 to plunger 25, hence orienting said stamp 43 to printable stock.

Said stamp 43, will be understood that ink is applied of appropriate quantity to the stamp 43 image, as applied via an ink pad by two methods. One method is to place the ink pad directly under the stamp 43 on bed 10 surface without moving or disturbing any settings of the sliders and rulers, then applying downward force on plunger cap 26 to make contact of the stamp 43 with ink pad. The second method is by placing ink pad on the turning radius of support shaft 22. Referring to FIG. 1 and FIG. 4, turning radius is accomplished by lifting support shaft 22 upwards against shaft spring 41 pressure, causing the releasing of boss pin 21 out of boss groove 20 located on top of boss 19. Boss 19 is fixed to bed 10. By rotating support shaft 22 away from bed 10, one can align stamp 43 over ink pad. The user exerts downward fingertip force or other mechanical means, on plunger cap 26 causing plunger 25 to travel downwards through guide 23. The user releases downward force causing plunger spring, (not shown) inside plunger 25 to return plunger 25 to its upward position. The user rotates support shaft 22 over bed 10, again aligning boss pin 21 over boss groove 20. Shaft spring 41 then forces boss pin 21 into boss groove 20, once alignment is made, hence, returning support shaft 22 to original alignment.

In both inking method, referring to FIG. 1 and FIG. 5, as stated above, the user will apply downward pressure onto the plunger cap 26. Once stamp 43 comes in contact with the ink pad, gauge sleeve 32 starts to move up the indicator 29. This is caused by the collapsing said gauge spring 31 located between rotator 28 and upper plate 34. This movement causes said gauge sleeve 32 to slide the reference ring 33 upwards along the indicator 29. Once the desired pressure has been reached, the user slowly releases the downward force and slowly allows the plunger 25 to rise to its neutral state. This causes the reference ring 33 to remain at its current position on the rotator 28. The user will note the pressure that has been applied by the position of reference ring 33 on indicator 29. The noted pressure will then be used to repeat the operation of image transfer in a repetitive operation, hence creating the same density by applying the same pressure on the stamp image onto the stock paper and ink pad. It will be understood that the user will manually move the reference ring 33 down the rotator 28 to make contact with gauge sleeve 33 whenever a new setting is required.

For stamp image transfer, the user then exerts downward force on plunger cap 26 causing plunger 25 to travel downwards through guide 23, until gauge sleeve 32 comes in contact with the reference ring 33. At this point the downward forced is ceased and stamp image is transferred to the sheet of printing stock. The user slowly reverses the downward force, which slowly allows the plunger 25 to rise to its neutral state. This operation can be repeated with a new sheet of paper stock without re adjusting sliders and rulers for repetitive stamping.

### CONCLUSION, RAMIFICATIONS, AND SCOPE

While in the foregoing a preference has been expressed for certain types of materials and for certain sizes and dimensions, it will be understood that other materials and other sizes and dimensions may be used without departing from the spirit of this embodiment. Accordingly, the reader will see that I have provided at least one embodiment of the stamp press that provides a more reliable, lightweight, yet economical device that can be used by persons of almost any age. While I have shown and described in the forgoing preferred embodiment of my invention, the same is not to be limited to the details illustrated and described, except as defined in the appended claims.

I claim:

1. A stamp printing apparatus comprising, a fix stamp means, a movable plunger, a movable printable stock guiding means, and a flat bed, wherein;
(a) said flat bed as defining a hard smooth upper surface for receiving and supporting of said printable stock, and
(b) user of said apparatus can adjust the relative position of said printable stock by means of slidable guides, and
(c) said slidable guides means consist of two slots, and
(d) said slots traversing perpendicular to the each other, and
(e) said guides allow movement of a measuring device to orient said printable stock in desired position, and
(f) said bed will have a support a shaft which a plunger is attacked to, and
(g) said stamp fix means for said stamp to be oriented image side down, and
(h) said stamp is interchangeable with thin mat with image inscribed on it, which is used to transfer image to paper stock.
(i) said plunger allows vertical movement of said stamp, and
(j) said printable stock guide means for positioning of said printable surface under the stamp image surface, and
(k) said apparatus allows stamping process via fingertip pressure or light mechanical pressure means, and wherein said pressure means is applied to apparatus said plunger, resulting in printable stock to stamp image contact, and wherein said pressure is applied in small section of said image area, cumulatively covering the entire area of said image.

2. An apparatus of claim 1 wherein said stamp positioning means includes said guides that allow adjustment and subsequent means for orienting of said printable stock to the relative position of said stamp.

3. An apparatus of claim 1 wherein adjustable or otherwise movable said guides are placed within said apparatus to allow positioning of said printable stock with respect to said stamp.

4. An apparatus of claim 1 that includes a means for position variable sizes of stamp to said plunger.

5. An apparatus of claim 1 wherein additional means for provided to further support for alignment of printable stock.

6. An apparatus of claim 1 wherein the stamp positioning means for printing with horizontal-oriented to stamp surface.

7. An apparatus of claim 1 wherein the inking density means for printing with an equal pressure applied to stamp surface.
